(19) United States
(12) Patent Application Publication
(10) Pub. No.: US 2003/0137479 A1
(43) Pub. Date: Jul. 24, 2003

(54) Planar display device for generating gradation voltage by use of resistance elements

(75) Inventor: Nobuo Yamasaki, Saitama-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/341,518

(22) Filed: Jan. 14, 2003

(30) Foreign Application Priority Data
Jan. 18, 2002 (JP) 2002-010245

(51) Int. Cl. G09G 3/36

(52) U.S. Cl. 345/89

(57) ABSTRACT

When a gradation voltage corresponding to video data is selected by switching elements, switching noises occur and the image quality reduces. In a planar display device of the present invention, capacitance elements C1, C2, C3, . . . and Cm are respectively connected to resistance elements R1, R2, R3, . . . and Rn, which divide a power source voltage and generate gradation voltages of plural levels. Each capacitance element C is formed in an external substrate 102. With such constitution, the switching noises are absorbed by the capacitance elements C, and propagation of the switching noises to signal lines D is suppressed.

### CROSS-REFERENCE TO RELATED APPLICATIONS

This application is based upon and claims the benefit of priority from Japanese Patent Application No. 2002-10245 filed Jan. 18, 2002; the entire contents of which are incorporated herein by reference.

### BACKGROUND OF THE INVENTION

1. Field of the Invention

The present invention relates to a planar display device for generating a gradation voltage corresponding to video data by dividing a power source voltage with a plurality of resistance elements.

2. Description of Related Art

Recent years, a planar display device typified by a liquid crystal display device has spread as display devices for various kinds of appliances because of its lower power consumption in addition to its thin structure and lightweight. Especially, since the planar display device using a polysilicon thin film transistors (p-Si TFTs) as switching elements can form a display section, data driver, and scan driver integrally in an array substrate, this planar display device achieves a high precision, a compact sized shape and light weight.

The data driver for supplying video data to signal lines adopt a digital input type, because it shows little fluctuation of the video data. As one of such digital input types, so-called a voltage selection type has been known.

This type of data driver selects a gradation voltage corresponding to video data of a digital signal to write it to a signal line. The gradation voltages of plural levels are generated by dividing power source voltage with a plurality of resistance elements. A switching element is provided for each resistance, and the gradation voltage corresponding to the video data is selected by the switching element. However, in the conventional planar display device, there has been a problem that switching noises caused when the gradation voltage is selected propagate to signal lines, and reduce the image quality.

### SUMMARY OF THE INVENTION

A planar display device of the present invention comprises a display section including scanning lines and signal lines wired in the form of matrix and a pixel arranged for each element of the matrix, a scan driver configured to output a scanning signal to the each scanning line, and a data driver including a gradation voltage generator configured to generate gradation voltages of plural levels by dividing a power source voltage with a plurality of resistance elements and a gradation voltage selector configured to select a gradation voltage corresponding to video data with switching elements, the data driver outputting the selected gradation voltage as an analog signal to the signal line. A capacitance element is electrically connected to at least one of the resistance elements.

The display section, the scan driver, and the data driver in which polysilicon thin film transistors are used as switching elements are formed in an array substrate, and the capacitance element is formed in an external substrate.

The capacitance element is electrically connected to the resistance elements that generate gradation voltages of intermediate tones.

### BRIEF DESCRIPTION OF THE DRAWINGS

FIG. 1 is a block diagram showing the entire structure of a planar display device of one embodiment.

FIG. 2 is a circuit diagram showing a constitution of a data driver shown in FIG. 1.

### DETAILED DESCRIPTION OF EMBODIMENT

Embodiment in which a planar display device of the present invention is applied to a liquid crystal display device will be described below. In the following description, the term “connect” means a state in which two elements are electrically connected to each other without regard to whether or not there is a physical connection between the elements.

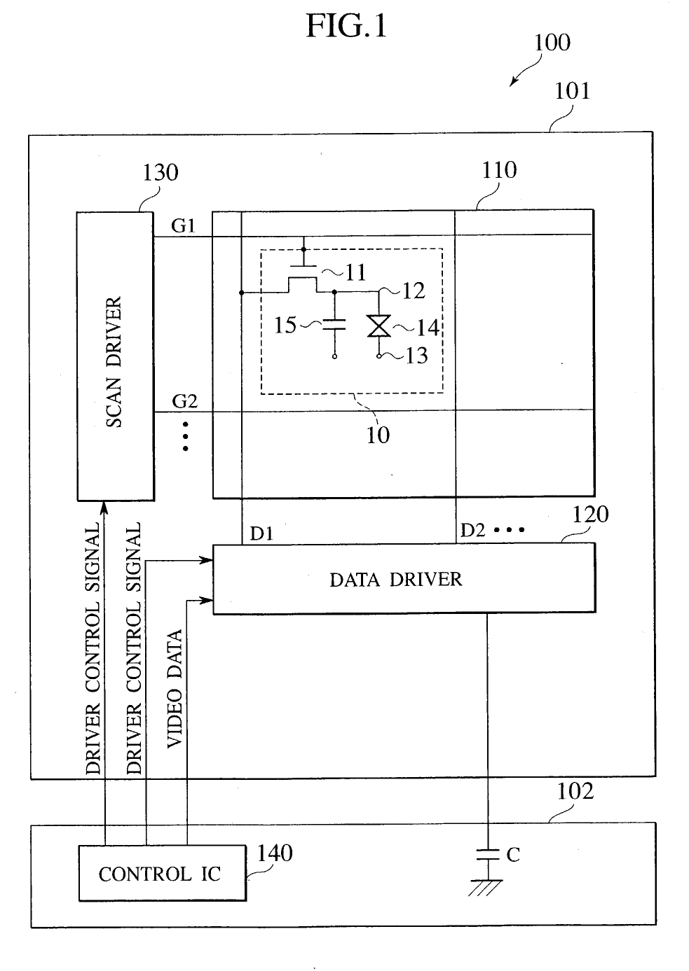

As shown in a block diagram of FIG. 1, a display section 110, a data driver 120 and a scan driver 130, which drive the display section 110, are formed in an array substrate 101.

The display section 110 comprises a plurality of signal lines D1, D2, . . . (hereinafter referred generically to as D) and a plurality of scanning lines G1, G2, . . . (hereinafter referred generically to as G). The signal lines D and the scanning lines G are wired in the form of matrix. Pixels 10 are arranged for each element of the matrix. In order to simplify, the only one of pixels 10 is shown in FIG. 1. One end of each of the signal lines D is connected to the data driver 120, and one end of each of the scanning lines G is connected to the scan driver 130.

A pixel switching element 11, a pixel electrode 12, an opposite electrode 13, a liquid crystal layer 14 and an auxiliary capacitance 15 constitute the pixel 10.

The source of the pixel switching element 11 is connected to the signal line D, and the gate of the pixel switching element 11 is connected to the scanning line G. The drain of the pixel switching element 11 is connected to the pixel electrode 12 and the auxiliary capacitance 15. The pixel switching element 11 is controlled so as to be turned on or off by a scanning signal that is supplied to the scanning line G. When the pixel switching element 11 is turned on, the signal line D and the pixel electrode 12 electrically conduct, and the video data supplied to the signal line D is written to the pixel electrode 12.

A liquid crystal layer 14 as a display layer is filled between the array substrate 101 and an opposite substrate (not shown). A sealing member (not shown) seals the surrounding of the array substrate 101 and the opposite substrate. The opposite electrode 13 is formed on the surface of the opposite substrate. A voltage for the opposite electrode 13 (hereinafter referred to as an opposite electrode voltage) is supplied from an external substrate 102 so that the opposite electrode 13 and the pixel electrode 12 in the same pixel are electrically opposed.

The video data written to the pixel electrode 12 is charged between the pixel electrode 12 and the opposite electrode 13 as a signal voltage. The liquid crystal layer 14 responses to the signal voltage, whereby a pictorial image is displayed on the pixel 10.

The data driver 120 comprises a gradation voltage generator, a gradation voltage selector, a signal line selector and a digital controller, which are to be described later. Video data of a digital signal and driver control signals are supplied from a control IC 140 of the external substrate 102 to the data driver 120. In the data driver 120, the gradation voltage selector and the signal line selector are operated based on the driver control signal, the video data is outputted as an analog signal to each signal line D for each predetermined period.

The scan driver 130 comprises a shift register, a level shifter and a buffer circuit, which are not shown. The scan driver 130 outputs a scanning signal to each scanning line G based on the driver control signal supplied from the control IC 140.

The external substrate 102 comprises a power source voltage generator (not shown) besides the control IC 140. The control IC 140 supplies the driver control signal, which includes clock signal and start signal, for controlling the operations of both of the drivers, the video data of the digital signal, the opposite electrode voltage, an auxiliary capacitance voltage and the like to a liquid crystal panel 100. The power source voltage generator supplies a power source voltage to each driver. The external substrate 102 may be any one of a rigid substrate or a flexible substrate.

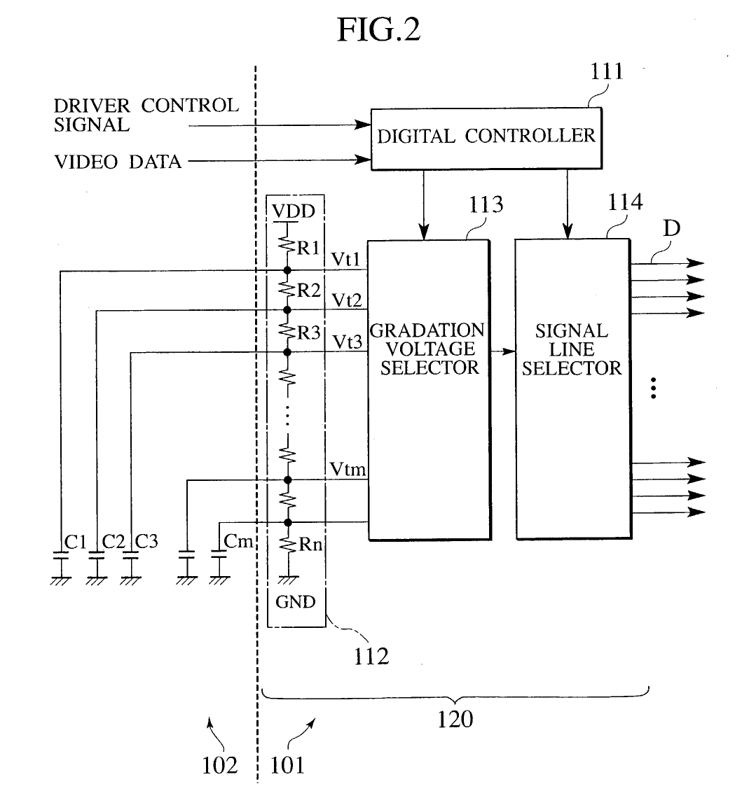

Next, a constitution of the data driver 120 will be described in detail. As shown in the circuit diagram of FIG. 2, the data driver 120 comprises the digital controller 111, the gradation voltage generator 112, the gradation voltage selector 113 and the signal line selector 114.

The digital controller 111 is a control circuit constituted by a shift register, a data latch and the like. The digital controller 111 controls operation timings of the gradation voltage selector 113 and the signal line selector 114 based on the driver control signal. The digital controller 111 converts the series video data to parallel data, and outputs it to the gradation voltage selector 113.

The gradation voltage generator 112 is constituted by a plurality of resistance elements R1, R2, R3, . . . and Rn connected in series. Gradation voltages of plural levels are generated by dividing a power source voltage with the resistance elements R. In this embodiment, the power source voltage VDD is supplied from the power source generator. The gradation voltage generator 112 generates the gradation voltages Vt1, Vt2, Vt3, . . . and Vtm of m levels (m: the number of gradations) between the VDD and the ground voltage GND, outputs the gradation voltages to the gradation voltage selector 113. Capacitance elements C1, C2, C3, . . . and Cm (hereinafter referred generically to as C) are connected to the resistance elements R1, R2, R3, . . . and R, respectively. For example, the respective resistance elements R have a resistance value equal to each other, and the respective capacitance elements C have a capacitance value equal to each other. The capacitance elements C are formed in the external substrate 102 as shown in FIG. 1. This is because polysilicon thin film transistors (p-Si TFTs) are used as switching elements in the array substrate 101, it is very difficult to manufacture the planar display device so that the capacitor elements C having a large capacity are in the array substrate 101.

The gradation voltage selector 113 is constituted by switching elements (not shown) of plural stages. The gradation voltage selector 113 selects a gradation voltage among Vt1, Vt2, Vt3, . . . and Vtm corresponding to the video data that is supplied from the control IC 140 through the digital controller 111. The gradation voltage selector 113 outputs this selected gradation voltage to the signal line selector 114 as an analog signal.

The signal line selector 114 selects a signal line D to which the analog signal is to be supplied, and amplifies this analog signal to a level necessary for outputting this analog signal to the signal line D.

When the gradation voltage selector 113 selects the gradation voltage corresponding to the video data, the switching noises due to the switching elements within it occur. However, the switching noises are absorbed by the capacitance elements C1, C2, C3, . . . and Cm corresponding to the respective switching elements. Thus, little switching noise propagates to the signal line, and it is possible to prevent the level fluctuation of the gradation voltages.

Accordingly, the video data of analog signal having the gradation level nearly equal to a design value will be written to the pixel electrode 14, and the image quality can be improved.

Furthermore, since a capacitance of large capacity, for example, a chip stacked type ceramic capacitance, can be formed in the external substrate 102, the capacitance elements C can be constituted by use of such capacitance, whereby it is possible to secure capacitance components of sufficient capacity required to reduce the switching noises.

In the above embodiment, the example in which the capacitance elements C1, C2, C3, . . . and Cm are respectively connected to the plurality of resistance elements R1, R2, R3, . . . and Rn was described. However, it is unnecessary to connect the capacitance elements C to all of the resistance elements R, it is satisfactory that the capacitance elements C may be connected to at least one of the resistance elements R. For example, one capacitance element C may be connected to a resistance element R at intervals of one-to-three resistance elements respectively. Furthermore, the capacitance elements C may be connected to the only resistance elements R generating gradation voltages of intermediate tones that are used frequently.

In the above embodiment, the present invention was applied to the liquid crystal display device. However, the present invention can be also applied to planar display devices having another display layer.

What is claimed is:

1. A planar display device, comprising:
a display section including scanning lines and signal lines wired in the form of matrix, and a pixel arranged for each element of the matrix;
a scan driver configured to outputting a scanning signal to the each scanning line;
a data driver including a gradation voltage generator configured to generate gradation voltages of plural levels by dividing a power source voltage with a plurality of resistance elements, and a gradation voltage selector configured to select a gradation voltage corresponding to video data with switching elements, the data driver outputting the selected gradation voltage as an analog signal to the signal line; and
a capacitance element electrically connected to at least one of the resistance elements.

2. The planar display device according to claim 1, wherein the display section, the scan driver, and the data driver in which polysilicon thin film transistors are used as switching elements are formed in an array substrate, and the capacitance element is formed in an external substrate.

3. The planar display device according to claims 1 or 2, wherein the capacitance element is electrically connected to the resistance elements that generate gradation voltages of intermediate tones.
